(19) United States
(12) Patent Application Publication
(10) Pub. No.: US 2008/0238235 A1
(43) Pub. Date: Oct. 2, 2008

(54) MOTOR AND COMPRESSOR USING THE SAME

(76) Inventors: Akeshi TAKAHASHI, Otaru (JP); Satoshi Kikuchi, Naka (JP); Hiroyuki Mikami, Hitachinaka (JP); Kazuo Nishihama, Hitachi (JP); Tomio Yoshikawa, Mishima (JP); Baiying Huang, Shizuoka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/019,680

(22) Filed: Jan. 25, 2008

(30) Foreign Application Priority Data
Mar. 28, 2007 (JP) 2007-083248

(51) Int. Cl. H02K 21/00

(52) U.S. Cl. 310/156.78

(57) ABSTRACT

A self-starting permanent magnet synchronous motor which demonstrates satisfactory acceleration performance even at a reduced supply voltage or with an increased load torque, and a compressor using the same. The motor comprises a stator having a stator winding and a rotor having a cage winding and a permanent magnet on the rotor core. The torque component generated by the cage winding is maximal at 1 in the slip range of 0 to 1.

### CLAIM OF PRIORITY

The present application claims priority from Japanese application serial No. 2007-83248, filed on Mar. 28, 2007, the content of which is hereby incorporated by reference into this application.

### BACKGROUND OF THE INVENTION

1. Field of the Invention

The present invention relates to a permanent magnet synchronous motor and a compressor which uses the same.

2. Description of the Related Art

Among compressors mounted in electric refrigerators and air conditioners and so on, induction motors have been used as driving sources for constant speed compressors, which do not require speed control. Generally, since output of a motor is proportional to its revolution speed and torque, for maximization of its output an induction motor is designed so that its torque is maximal around synchronous speed when slip of the motor is equal to 0.

On the other hand, with the growing demand for higher efficiency, development of a self-starting permanent magnet synchronous motor which can start by itself with a commercial power source and permits highly efficient operation is anticipated. For example, JP-A-2001-86670 proposes The self-starting permanent magnet synchronous motor uses a torque component generated by a cage winding formed of a conductor bar at start of the motor for acceleration and is designed so that the torque component generated by the cage winding is maximal around synchronous speed (slip 0) similarly as in conventional induction motors.

However, the torque at 0 speed of the motor (slip 1) is generally small in the above design. Therefore, acceleration performance deteriorates if the motor starts at a poor condition such as reduced supply voltage or with an increased load torque applied. Although conventional induction motors are designed to be able to accelerate even in such a situation, it is difficult for the self-starting permanent magnet synchronous motor to assure satisfactory acceleration performance at a reduced supply voltage or with an increased load torque, based on the conventional technique. Because its acceleration performance considerably deteriorates under the influence of brake torque due to the magnet.

However, in the above design, as shown in FIG. 2, generally the torque (T_{A}) at 0 speed or at start of the motor (slip 1) is small. Also when the motor is started at a reduced supply voltage, the torque (T_{B}) at 0 speed or at start (slip 1) is smaller than T_{A}, as shown in FIG. 2, suggesting deterioration in acceleration performance. In addition, if the motor is started with a large load torque applied, its acceleration performance deteriorates. While the conventional induction motor is designed to be able to accelerate even in such a situation, in case of the self-starting permanent magnet synchronous motor the acceleration performance considerably deteriorates under the influence of brake torque due to the permanent magnet. Therefore, it is difficult for the self-starting permanent magnet synchronous motor to assure satisfactory acceleration performance at a reduced supply voltage shown in FIG. 3 or with an increased load torque, based on the conventional technique. In FIG. 3, the motor speed can not rise to the synchronous speed under the insufficient supply voltage.

### SUMMARY OF THE INVENTION

According to the present invention, a self-starting permanent magnet synchronous motor having a rotor with a permanent magnet is designed so that the torque component generated by a cage winding is maximal in the slip range which has the value from 0 to 1.

According to the present invention, it is possible to provide a self-starting permanent magnet synchronous motor which demonstrates satisfactory acceleration performance even at a reduced supply voltage or with an increased load torque, and a compressor using the same.

According to one aspect of the present Invention, a self-starting permanent magnet synchronous motor comprising, a stator having a stator winding, and a rotor having a rotor core with a cage winding and a permanent magnet provided on the rotor core, wherein a torque component generated by the cage winding is maximal at slip 1.

### BRIEF DESCRIPTION OF THE DRAWINGS

The invention will be more particularly described with reference to the accompanying drawings, in which:

FIG. 1 is a radial sectional view of a rotor of a self-starting permanent magnet synchronous motor according to a first embodiment of the invention;

FIG. 2 is a graph which shows the relation between the torque generated by a cage winding and revolution speed in a conventional induction motor;

FIG. 3 is a graph which shows the speed characteristic concerning the conventional technique;

FIG. 4 is a graph which shows the relation between the torque generated by a cage winding and revolution speed according to the first embodiment of the invention;

FIG. 5 is a radial sectional view of a rotor of a self-starting permanent magnet synchronous motor according to a second embodiment of the invention;

FIG. 6 is an axial sectional view of a rotor of a self-starting permanent magnet synchronous motor according to the second embodiment of the invention;

FIG. 7 is a graph which shows the relation between the torque generated by a cage winding and revolution speed according to the second embodiment of the invention;

FIG. 8 is a radial sectional view of a rotor of a self-starting permanent magnet synchronous motor according to a third embodiment of the invention;

FIG. 9 is a radial sectional view of a rotor of a self-starting permanent magnet synchronous motor according to a fourth embodiment of the invention;

FIG. 10 is a radial sectional view of a rotor of a self-starting permanent magnet synchronous motor according to a fifth embodiment of the invention;

FIG. 11 is an axial sectional view of a rotor of a self-starting permanent magnet synchronous motor according to the fifth embodiment of the invention;

FIG. 12 is a graph which shows the relation between cage winding size and induced electromotive force according to the fifth embodiment of the invention;

FIG. 13 is a radial sectional view of a rotor of a self-starting permanent magnet synchronous motor according to a sixth embodiment of the invention; and

FIG. 14 is a axial sectional view of a compressor according to an embodiment of the invention.

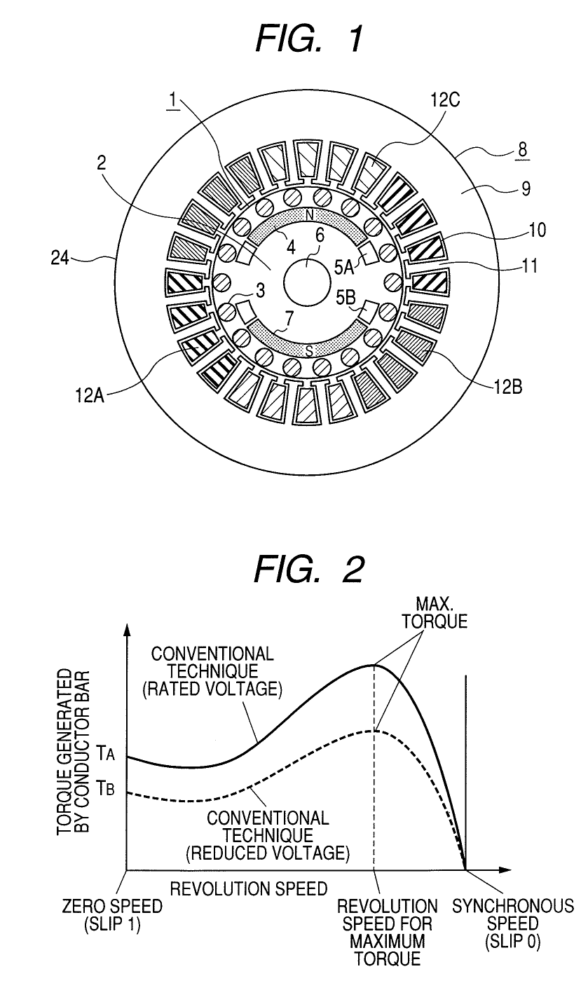

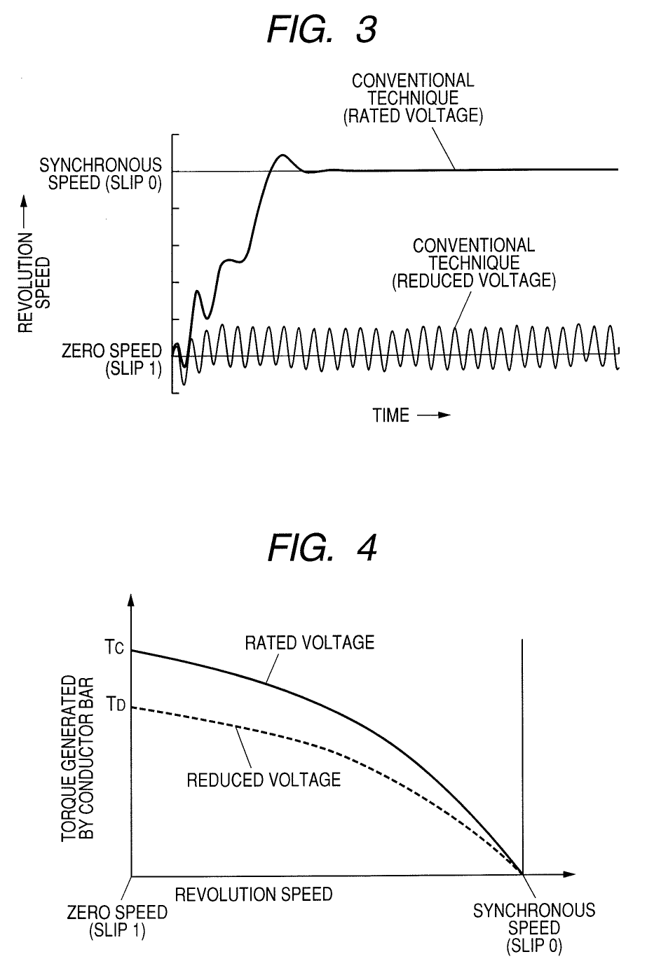

### DETAILED DESCRIPTION OF THE PREFERRED EMBODIMENTS

Next, the preferred embodiments of the present invention will be described referring to the accompanying drawings.

### First Embodiment of the Invention

FIG. 1 is a radial sectional view of a rotor of a self-starting permanent magnet synchronous motor according to a first embodiment of the invention. As shown in the figure, a rotor 1 is structured as follows: inside a rotor core 2 on a shaft 6, a plurality of starting cage windings 3 (18 cage windings in this example) and a pair of rare earth-based permanent magnet 4 buried in magnet insertion holes 7 are arranged so as to make two poles. A vacant hole 5 is provided between magnetic poles of the permanent magnet 4. The rotor core 2 may be formed of a powder molding such as a sintered magnetic core. Furthermore, the rotor core 2 and the permanent magnet 4 may be formed by integral molding. Also, the cage winding 3 may be formed of a die casting or made by friction-stir welding. The material of the cage winding 3 may be aluminum, copper or another conductive material. The radial sectional shape of the cage winding 3 may be circular, oval or wedge. A stator 8 includes a stator core 9 and a plurality of slots 10 made therein, 24 slots in this example, and a plurality of teeth 11 partitioned by these slots 10. An armature winding 12 comprises three types of windings, namely U-phase windings 12A, V-phase windings 12B and W-phase windings 12C, constituting a distributed winding where windings of each phase are distributed in plural slots 10. However, the armature winding 12 may be formed by a single-phase winding.

FIG. 4 shows the relation between the torque generated by the cage winding 3 and revolution speed in the self-starting permanent magnet synchronous motor according to the present invention. As shown in FIG. 4, the present invention is designed so that the torque component generated by the cage winding 3 is maximal at slip 1. Consequently the torque at 0 speed or at start of the motor (slip 1) is as large as T_{C} in FIG. 4. Even at a reduced voltage, a relatively large torque as shown as T_{D} in FIG. 4 is achieved. Therefore, according to the present invention, it is possible to provide a self-starting permanent magnet synchronous motor which demonstrates satisfactory acceleration performance at a reduced supply voltage or with an increased load torque and also provide a compressor using the same.

Pulling into synchronism refers to transition to synchronous speed operated as a permanent magnet motor after acceleration operated as an induction motor. The pulling into synchronism occurs when the rotor 1 has been sufficiently accelerated, or the speed difference between the revolving magnetic field generated by the armature winding 12 and the rotor 1 is small (slip range of 0.2-0.4 or so). In this condition, the time duration of torque generation by the permanent magnet 4 in the forward revolution direction is longer than at speed 0 of the motor. Then most of the torque required for pulling into synchronism can be generated by the permanent magnet 4 and as a consequence, the small torque component generated by the cage winding 3 is enough for the synchronism.

On the other hand, at speed 0 of the motor, the speed difference between the revolving magnetic field generated by the armature winding 12 and the rotor 1 is large. And the permanent magnet 4 generates torques in the forward and reverse revolution directions alternately in short cycles and thus the torque generated by the permanent magnet 4 does not contribute largely to acceleration. Hence, the torque generated by the cage winding 3 at 0 speed must be increased so as to assure satisfactory acceleration performance even at a reduced supply voltage or with an increased load torque.

Characteristic data on the torque generated by the cage winding 3 of the self-starting permanent magnet synchronous motor is shown in FIG. 4. The characteristic data is obtained by measurement on an actual motor reassembled after removing the permanent magnet 4 from its rotor 1. Or the data is obtained by measurement on an actual motor after heating the motor in a hot bath of 300° C. or more to demagnetize the permanent magnet 4.

### Second Embodiment of the Invention

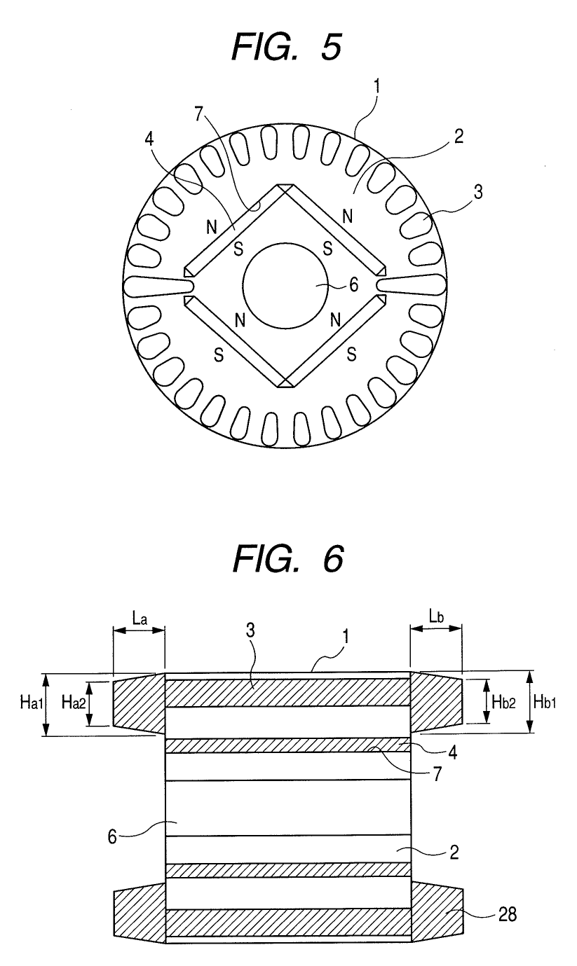

FIG. 5 is a radial sectional view of a rotor of a self-starting permanent magnet synchronous motor according to a second embodiment of the invention. In this embodiment, the spacing between neighboring cage winding become gradually smaller as the cage winding location is approaching from the area adjacent to the poles to the area between poles. FIG. 6 is an axial sectional view of the rotor shown in FIG. 5. In FIGS. 5 and 6, the same elements as shown in FIG. 1 are designated by the same reference numerals and their descriptions are omitted here.

Generally, torque component T generated by the cage winding 3 of the self-starting permanent magnet synchronous motor as shown in FIG. 5 is expressed by Expression (1) as follows.

$$\begin{matrix}[ Expression 1 ] & \\ T = \frac{3 {V}_{1}^{2} \frac{{r}_{2}}{s} p}{4 π f \{ {( {r}_{1} + \frac{{r}_{2}}{s} )}^{2} + {( {x}_{1} + {x}_{2} )}^{2} \}} & ( 1 )\end{matrix}$$

Here, V₁ represents the value of actual voltage applied to one phase of the armature winding 12, f: voltage frequency, P: the number of poles, s: slip, r₁: resistance for one phase of the armature winding 12, r₂: resistance of the cage winding 3 multiplied by squared turn ratio a, x₁: leakage reactance for one phase of the armature winding 12, and x₂ leakage reactance of the cage winding 3 multiplied by squared turn ratio a.

Torque component T generated by the cage winding 3 is maximal when slip s is expressed by Expression (2).

$$\begin{matrix}[ Expression 2 ] & \\ s = \frac{2}{\sqrt{{r}_{1}^{2} + {( {x}_{1} + {x}_{2} )}^{2}}} & ( 2 )\end{matrix}$$

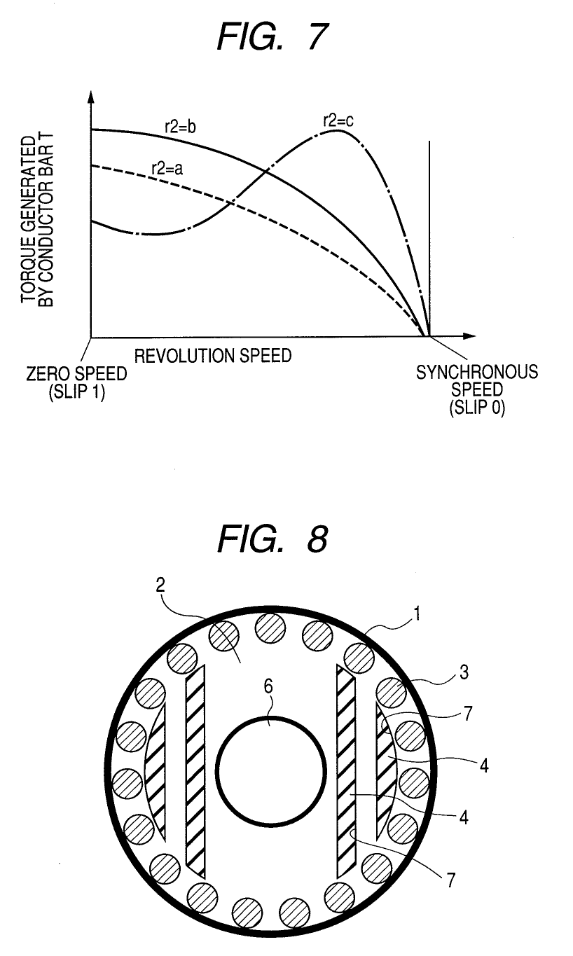

If r₁, x₁ and x₂ are constant, s is proportional to r₂. FIG. 7 shows the relation between torque T generated by the cage winding 3 and revolution speed in connection with r₂, where the relation of a>b>c exists. As shown in FIG. 7, when r₂ is small (r₂=c), torque T is maximal when the slip is less than 1 (s<1) and the torque is small at 0 speed (s=1). In this case, it is difficult to assure satisfactory acceleration performance at a reduced supply voltage or with an increased load torque. On the other hand, when r₂ is increased (r₂=b), such feature will obtained that the torque is maximal when s=1, which assures good acceleration performance. When r₂ is further increased (r₂=a), theoretically torque T is maximal when s>1, but in case of 0≦s≦1, torque T is maximal when s=1, which means that “r₂=a” may be a possible option as far as satisfactory acceleration performance is achieved at a reduced supply voltage or with an increased load torque.

r₂ may be increased by rising turn ratio α or using a material with high resistivity for the cage winding 3 or by decreasing the circumferential and radial widths of the cage winding 3 as shown in FIG. 5. Or r₂ may be enlarged by decreasing axial lengths Lₐ, L_{b} of an end ring 28 and its radial widths Hₐ₁, Hₐ₂, H_{b1} and H_{b2} as shown in FIG. 6. Particularly when r₂ is increased by decreasing the radial width of the cage winding 3, the space for burying the permanent magnet 4 is enlarged and thus a higher efficiency and an improved maximum torque in synchronous operation are achieved.

### Third Embodiment of the Invention

FIG. 8 is a radial sectional view of a rotor of a self-starting permanent magnet synchronous motor according to a third embodiment of the present invention, where a plurality of permanent magnets are provided for one pole of the rotor. In FIG. 8, the same elements as shown in FIG. 1 are designated by the same reference numerals.

In this embodiment as well, the torque T can be maximized by increasing r₂ when s=1, same as in the second embodiment.

### Fourth Embodiment of the Invention

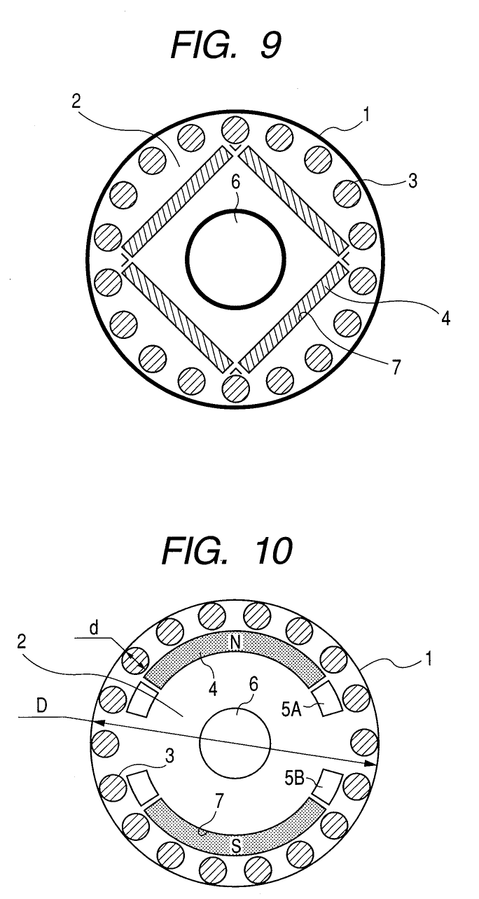

FIG. 9 is a radial sectional view of a rotor of a self-starting permanent magnet synchronous motor according to a fourth embodiment of the present invention. In this embodiment, a permanent magnet with the shape of equal length angle bar in radial sectional view, or unequal angle bar is provided for each pole of the rotor. In FIG. 9, the same elements as shown in FIG. 1 are designated by the same reference numerals.

In this embodiment as well, the torque T can be maximized by increasing r₂ when s=1, same as in the second embodiment.

### Fifth Embodiment of the Invention

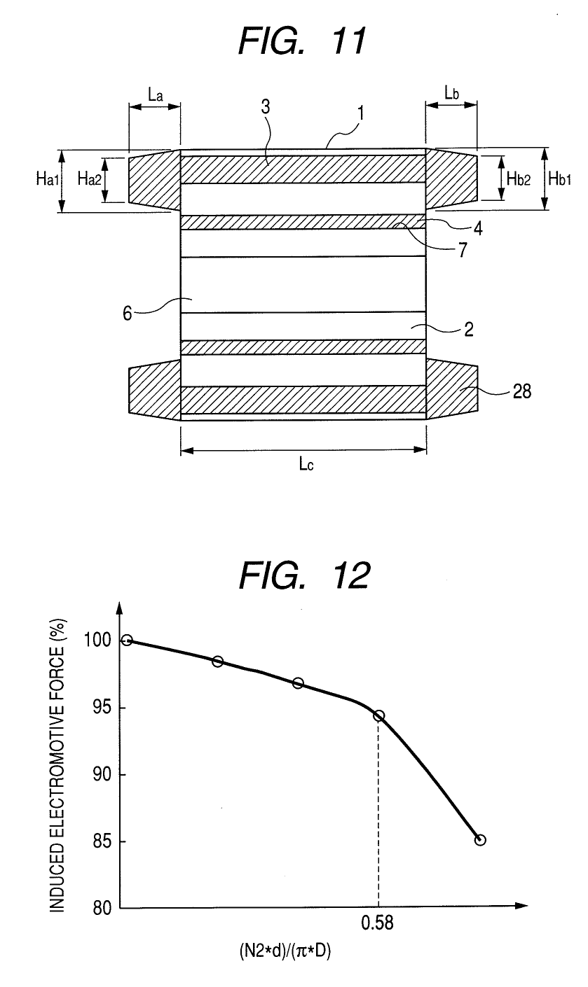

FIG. 10 is a radial sectional view of a rotor of a self-starting permanent magnet synchronous motor according to a fifth embodiment of the present invention. FIG. 11 is an axial sectional view of the rotor shown in FIG. 10. In FIGS. 10 and 11, the same elements as shown in FIG. 1 are designated by the same reference numerals.

Referring to FIGS. 10 and 11, an end ring 28 is made of aluminum or a material whose resistivity is almost equivalent to that of aluminum and its dimensions satisfy the following Expressions from (3) to (7).

$$\begin{matrix}[ Expression 3 ] & \\ \frac{{L}_{a} + {L}_{b}}{{L}_{c}} \leq 0.5 & ( 3 ) \\ [ Expression 4 ] & \\ \frac{{H}_{a 1}}{D} \leq 0.25 & ( 4 ) \\ [ Expression 5 ] & \\ \frac{{H}_{a 2}}{D} \leq 0.25 & ( 5 ) \\ [ Expression 6 ] & \\ \frac{{H}_{b 1 }}{D} \leq 0.25 & ( 6 ) \\ [ Expression 7 ] & \\ \frac{{H}_{b 2}}{D} \leq 0.25 & ( 7 )\end{matrix}$$

When the relation among outside diameter D of the rotor 1, maximum circumferential width d of each cage winding 3, and the number of slots N₂ for cage windings 3 satisfies Expression (8), the torque generated by the cage winding 3 is maximal at slip 1.

$$\begin{matrix}[ Expression 8 ] & \\ \frac{{N}_{2} \cdot d}{π \cdot D} \leq 0.58 & ( 8 )\end{matrix}$$

For example, the slip condition is explained when the left-hand side of each of Expressions (3) to (8) is in the upper limit, i.e. (Lₐ+L_{b})/L_{c}=0.5, Hₐ₁/D=Hₐ₂/D=H_{b1}/D=H_{b2}/D=0.25, and (N₂*d)/(π*D)=0.58. In this case, the slip at which the torque generated by the cage winding 3 is maximal is calculated from Expression (2). And Table 1 shows slip data in relation with the number of slots in the stator 8 N₁ and the number of slots for cage windings 3 N₂.

TABLE 1

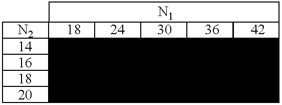

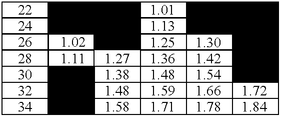

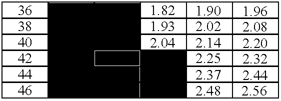

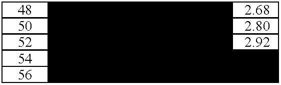

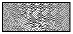

This type of grey cell denotes slip 1 or less. However, if Lₐ, L_{b}, Hₐ₁,
Hₐ₂, H_{b1} and H_{b2} are smaller, the slips can be 1 or more.

Slip data in Table 1 were calculated by varying the value of d according to the value of N₂ with the value of D constant so as to satisfy (N₂*d)/(π*D)=0.58. Here, the number of turns for each phase of the armature winding 12 is constant; however, even if the number of turns changes, it does not influence the value of s obtained from Expression (2).

Because r₁, r₂, x₁, and x₂ are all almost proportional to the square of the number of turns (in case of r₁, on the premise that the slot space factor of the armature winding 12 is constant).

If N₁ and N₂ at which slip is 1 or more are selected from Table 1, the torque generated by the cage winding 3 is maximal at slip 1 as far as the dimensions of the cage winding 3 and the dimensions of the end ring 28 satisfy Expressions (3) to (8).

Even if the end ring 28 is made of a material with low resistivity such as copper, the torque generated by the cage winding 3 can be made maximal at slip 1 by decreasing the dimensions of the end ring 28.

Here, the relation between (N₂*d)/(π*D) and induced electromotive force in the armature winding 12 is as shown in FIG. 12. If N₂ and D are constant, it is known from FIG. 12 that the larger d is, the smaller induced electromotive force is. This is because increase of d causes magnetic saturation in the iron part between neighboring cage windings 3 and makes transmission of the magnetic flux from the permanent magnet 4 to the stator 8 more difficult. Hence, a large induced electromotive force can also be achieved by setting d to a value which satisfies Expression (8).

### Sixth Embodiment of the Invention

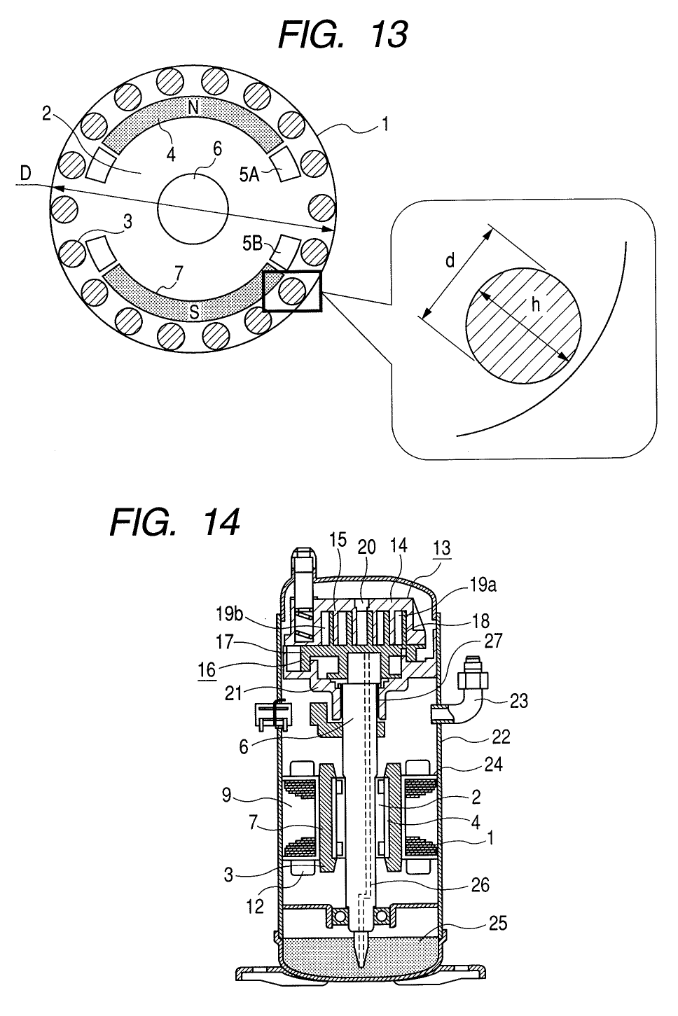

FIG. 13 is a radial sectional view of a rotor of a self-starting permanent magnet synchronous motor according to a sixth embodiment of the present invention. In FIG. 13, the same elements as shown in FIG. 1 are designated by the same reference numerals.

FIG. 13 assumes that the end ring 28 is made of aluminum and its dimensions satisfy Expressions (3) to (7). Here, the relation among outside diameter D of the rotor 1, maximum circumferential width d of each cage winding 3, and the number of slots N₂ for cage windings 3 satisfies Expression (8).

When the maximum radial width of one slot for a cage winding 3, h, satisfies Expression (9), the torque generated by the cage winding 3 is maximal at slip 1.

$$\begin{matrix}[ Expression 9 ] & \\ h \leq \frac{0.58 \cdot π \cdot D}{{N}_{2}} & ( 9 )\end{matrix}$$

The shape of the slot for each cage winding 3 may be circular, oval or wedge form in cross section.

### Seventh Embodiment of the Invention

FIG. 14 is a sectional view of a compressor according to an embodiment of the present invention. As shown in FIG. 14, the compression mechanism combines a spiral vane 15 standing upright on an end plate 14 of a stationary scroll member 13 and a spiral vane 18 standing upright on an end plate 17 of a spiral scroll member 16. As the spiral scroll member 16 is rotated by a crankshaft 6, compression is performed.

Among compression chambers 19 (19a, 19b and so on) formed by the stationary scroll member 13 and spiral scroll member 16, the outermost compression chamber 19 moves toward the centers of the scroll members 13 and 16 and its volume gradually decreases.

As the compression chambers 19a and 19b reach the vicinity of the centers of the scroll members 13 and 16, the compressed gas in the compression chambers 19 is discharged through a discharge port 20 communicated with the compression chambers 19. The discharged compressed gas passes through a gas path (not shown) provided in the stationary scroll member 13 and a frame 21 and reaches a pressure container 22 under the frame 21 and goes out of the compressor through a discharge pipe 23 on a side wall of the pressure container 22. The pressure container 22 incorporates a permanent magnet synchronous motor 24, comprised of a stator core 9 and a rotor 1 as illustrated in FIG. 1 and FIGS. 4 to 13, which rotates at a constant speed to perform compression.

An oil reservoir 25 is located under the synchronous motor 24. By a pressure difference generated by revolving movement, the oil in the oil reservoir 25 is passed through an oil hole 26 in the crankshaft 6 and supplied to sliding parts of the spiral scroll member 16 and crankshaft 6, slide bearing 27 and so on for lubrication.

As explained so far, the use of a self-starting permanent magnet synchronous motor as illustrated in related FIGS. as a motor for driving a compressor improves the self-starting characteristic and achieves a higher power factor, a higher efficiency and a larger torque in a constant speed compressor.

As apparent from the above explanation, according to the present invention, it is possible to provide a self-starting permanent magnet synchronous motor which demonstrates satisfactory acceleration performance even at a reduced supply voltage or with an increased load torque, and a compressor using the same.

What is claimed is:

1. A self-starting permanent magnet synchronous motor comprising:
a stator having a stator winding; and
a rotor having a rotor core with a cage winding and a permanent magnet provided on the rotor core,
wherein a torque component generated by the cage winding is maximal at slip 1.

2. The self-starting permanent magnet synchronous motor according to claim 1,
wherein:
the relation among an outside diameter D of the rotor, the number of slots N₂ of the rotor, and a maximum circumferential width d of each slot of the rotor satisfies an expression (N₂*d)/(π*D)≦50.58; and
as for maximum radial width h of one slot for the cage winding, an expression h≦0.58*π*D/N₂ holds.

3. The self-starting permanent magnet synchronous motor according to claim 1,
wherein:
the relation among axial end lengths Lₐ and L_{b} of a conductive end ring for shorting the cage winding on axial end faces, an axial length L_{c} of the rotor, and radial thicknesses Hₐ₁, Hₐ₂, H_{b1}, H_{b2} of the end ring satisfies the following expressions (Lₐ+L_{b})/L_{c}≦0.5, Hₐ₁/D≦0.25, Hₐ₂/D≦0.25, H_{b1}/D≦0.25, and H_{b2}/D≦0.25;
relation among an outside diameter D of the rotor, the number of slots N₂ of the rotor, and a maximum circumferential width d of one slot of the rotor satisfies an expression (N₂*d)/(π*D)≦0.58; and
as for maximum radial width h of one slot for the cage winding, an expression h≦0.58*π*D/N₂ holds.

4. The self-starting permanent magnet synchronous motor according to claim 1,
wherein:
the cage winding is made of aluminum or a material with a resistivity almost equivalent to that of aluminum;
the relation among axial end lengths Lₐ and L_{b} of a conductive end ring for shorting the cage winding on axial end faces, an axial length L_{c} of the rotor, and radial thicknesses Hₐ₁, Hₐ₂, H_{b1}, H_{b2} of the end ring satisfies the following expressions (Lₐ+L_{b})/L_{c}≦0.5, Hₐ₁/D≦0.25, Hₐ₂/D≦0.25, H_{b1}/D≦0.25, and H_{b2}/D≦0.25;
relation among an outside diameter D of the rotor, the number of slots N₂ of the rotor, and a maximum circumferential width d of each slot of the rotor satisfies an expression (N₂*d)(π*D)≦0.58; and
as for maximum radial width h of one slot for the cage winding, an expression h≦0.58*π*D/N₂ holds.

5. A compressor comprising:
a compression mechanism which takes in, compresses and discharges refrigerant; and
a motor according to claim 1 which drives the compression mechanism.

6. The self-starting permanent magnet synchronous motor according to claim 1, wherein a cage winding is provided in an area between poles of the rotor and wherein the spaces between adjacent cage winding become smaller as the location of the cage winding become nearer from the area adjacent to the poles to the area between poles of the rotor.

7. The self-starting permanent magnet synchronous motor according to claim 1, wherein a plurality of permanent magnets are provided for each pole of the rotor.

8. The self-starting permanent magnet synchronous motor according to claim 1, wherein a permanent magnet with an equal angle shaped bar in radial cross section or unequal angle shaped bar is provided for each pole of the rotor.

9. The self-starting permanent magnet synchronous motor according to claim 1, wherein a vacant hole is provided between poles of the permanent magnet.

10. A self-starting permanent magnet synchronous motor comprising:
a stator having a stator winding; and
a rotor having a rotor core with a cage winding and a permanent magnet provided on the rotor core,
wherein a torque component generated by the cage winding is maximal at 0 speed or at start of the motor.

11. A self-starting permanent magnet synchronous motor comprising:
a stator having a stator winding; and
a rotor having a rotor core with a cage winding and a permanent magnet provided on the rotor core,
wherein, when the permanent magnet is removed, a torque component of the cage winding is maximal at 0 speed or at start of the motor.

12. A self-starting permanent magnet synchronous motor comprising:
a stator having a stator winding; and
a rotor having a rotor core with a cage winding and a permanent magnet provided on the rotor core,
wherein, when the motor is installed in a hot bath, a torque component of the cage winding is maximal at 0 speed or at start of the motor.

13. The self-starting permanent magnet synchronous motor according to claim 12, wherein temperature of the hot bath is 300° C. or more.
